(19) United States
(12) Patent Application Publication
(10) Pub. No.: US 2015/0272137 A1
(43) Pub. Date: Oct. 1, 2015

(54) METHOD FOR MAKING HIGH NUTRITIONAL VALUE COOKIE PRODUCT

(71) Applicant: SYED IRFAN, Hyderabad (IN)

(72) Inventor: SYED IRFAN, Hyderabad (IN)

(21) Appl. No.: 13/941,456

(22) Filed: Jul. 13, 2013

(51) Int. Cl. A21D 10/00

(52) U.S. Cl. CPC A21D 10/002

(57) ABSTRACT

A method of making a high nutritional value cookie using a set of ingredients mixed into dough and baked at a set temperature. The ingredients in the mixture are mixed at optimal proportion to make the cookie delicious and the said mixture is of high nutritional content. The mixture is then with help of dropping machine dropped on baking tray and baked in an oven to bring out the final product which is tasty, has better shelf life, better eating quality and more nutritious.

This application claims benefit of Serial No. 2346/CHE/2013, filed on 29 May, 2013 in India and which application is incorporated herein by reference in its entirety.

### FIELD OF THE INVENTION

The invention relates to field of food products. More specifically, the invention relates to method of making a unique, novel and advantageous bakery food product, being a large and small size high nutritional and delicious cookie as food supplement.

### BACKGROUND AND DESCRIPTION OF PRIOR ART

With changing environment, the consumers are demanding for more processed foods and baked foods. The demands for such foods has increased . One such food as the special cookies which are made with clarified butter and are highly nutrient and tasty food products. Such baked food items are preferred as beak fast and as snack meal, not only for high nutritional value but also for taste. Also due to the demands and stresses of modern life, many people no longer have the time or the desire to create meals or desserts from scratch.

Instead, people often purchase ready-to-eat products that are prepared for immediate consumption without further preparation or ready-to-bake products that are prepared so as to go directly from the pantry, refrigerator or freezer to the oven or other associated baking appliance.

Currently the products that continue to gain in popularity is readily baked fresh cookies, which go from freshly prepared dough containing various ingredients and condiments for flavor, to be baked in a preheated oven. Such cookies serve as a fresh dessert to compliment a meal or as an in-between meal snack. Fresh cookies assure the consumer of better and good taste, high nutrition and of consistent quality. This is so because preparing such cookies from a scratch is not only time consuming but also could have preparation errors.

While the use of a plurality of alternative ingredients and dough's allows the formation of cookie, it would be advantageous to use other edible components that are not only nutritious but which simultaneously improved the taste of a finished cookie.

There are various cookies in the market place. Some existing cookies being manufactured are usually coated with various chocolate and fudge coatings and also using various other ingredients. While there have been significant advances in the art, further advances are possible. It is desirable to have a high nutritional value large cookie made from clarified buffalo butter, fine grade wheat flour, coarse wheat semolina, powdered sugar, grain sugar, buffalo semi dried milk, honey, dry fruits like almond, cashew nuts, raisins, condiments like saffaron, cardamom, milk powder, water, salt, ammonium bicarbonate in optimal proportions and yet highly nutritious.

In the light of aforementioned discussion there exists a need for a high nutritional value large cookie as food supplement.

### SUMMARY OF THE INVENTION

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

It is an objective of the present invention to prepare a highly nutrient large and small sized cookie.

It is an objective of the present invention to prepare a cookie to have a shelf life.

It is an objective of the present invention to prepare a cookie to have high quality of taste.

It is yet another objective of the present invention to prepare a highly nutritious nutrient and diet supplement baked cookie.

### DETAILED DESCRIPTION

It is to be understood that the present disclosure is not limited in its application to the details of construction and the arrangement of components set forth in the following description. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

The present invention is directed to a baked cookie where upon the ingredients are mixed in optimal quantity and proportionately. The said mixture is mechanically mixed by adoption a particular way of mixing to achieve such as viscosity which is vital for the cookie and is essential in maintaining the shape and the delicious taste of the cookie.

The cookie attains its high nutritional value through the adding of the said ingredients in optimal proportion and at the regular intervals during the mixing process. This is needed to maintain the perfect balance between taste and the eating quality aspect of the cookie.

A large and small sized cookie made from clarified buffalo butter, fine grade wheat flour, coarse wheat semolina, powdered sugar, grain sugar, semi dried buffalo milk, honey, dry fruits like almond, cashew nuts, raisins, condiments like saffron, cardamom, milk powder, water, salt, permitted yellow color ammonium bicarbonate wherein the cookie making process starts with the first part of the mixing and marinating coarse semolina and buffalo clarified butter. Then while the marinating takes place, the second part of the chilled dried buffalo milk and milk powder, powder sugar and grain sugar and cardamoms along with honey are taken in optimal proportions and mixed mechanically, with, some clarified butter of the required recipe is added during the mixing to the above said mixture. Then water, ammonium bicarbonate and salt mixture along with saffron and yellow food color is added. The marinated mixture is added to the second part in the mechanical mixer. Then the wheat flour is added along with dry fruits. As the mixture thickens and gets aerated , and attains a particular viscosity the mixing is done. The dough can be scooped into a tray or round pressed into a ball shape. The mixture is fed into the cookies dropping machine which again drops uniform weight size cookie by giving a particular shape, size, appearance in a set quantity on to a baking tray which has a particular thickness. Such dropped dough is then garnished with almonds or cashew or pistachio.

The tray with the dropped dough is put in a baking trolley which is then sent into an oven pre heated at a set temperature. The cookie is baked inside the oven continuously over a set time. After the baking is done, the cookie is brought out of the oven and let to cool off for half an hour. After the cookie cools, it is then packed or offered for consumption. Maintaining a perfect balance between the ingredients in the dough and mixing and baking process is essential for the cookie to have a longer shelf life good taste and eating quality.

What is claimed is:

1. A method of producing a high nutritional value cookie product, the method comprising: (a) forming a plurality of soft cookie dough pieces from a quantity of cookie dough; (b) providing the plurality of soft cookie dough pieces onto a movable conveyor for transporting the cookie dough pieces in a machine direction, wherein the cookie dough comprises a clarified buffalo butter; a wheat flour of fine grade; a wheat semolina; a powdered sugar; a grain sugar; semi chilled dried milk; a honey; dry fruits which are almonds, cashew nuts and raisins; condiments which are cardamom; a milk powder; water; salt; permitted yellow food color and saffron and ammonia bicarbonate and a combination thereof and (c) baking the pieces with a set temperature in a preheated oven to obtain individual baked cookies.

2. The method of claim 1, wherein the cookie product when baked, has a substantially homogenous cross-section with respect to flavor and appearance and shelf-stable cross-sectional texture variability.

3. The method of claim 1, wherein the grain sugar is a member selected from the group consisting of fructose, dextrose, semi dried buffalo milk, semolina together comprised in the solution therein.

4. The method of claim 1, is in the form of a block that defines pieces of different sizes or shapes.
